(19) United States
(12) Patent Application Publication
(10) Pub. No.: US 2003/0187998 A1
(43) Pub. Date: Oct. 2, 2003

(54) System and method for detecting resource usage overloads in a portal server

(76) Inventor: Patrick Petit, Grenoble (FR)

Correspondence Address: WAGNER, MURABITO & HAO LLP, Third Floor, Two North Market Street, San Jose, CA, 95113, US

(21) Appl. No.: 10/109,447

(22) Filed: Mar. 27, 2002

(51) Int. Cl. G06F 15/173

(52) U.S. Cl. 709/229; 709/226; 709/219

(57) ABSTRACT

In an enterprise portal server system having a server, a resource load detection method and system. The resource load detection system includes logic for determining threshold load values for optimal performance of the portal server. Current load values in the portal server are intermittently calculated during a load sampling period to determine whether resource overload conditions exist in the portal server during the load sampling period. In one embodiment of the present invention, resource overload is automatically detected, during a load sampling period, if the current load values exceed the pre-determined threshold load values. In one embodiment of the present invention, a maximum number of concurrent users that may connect to the portal server together with the average session time of user accesses to the portal server defines the optimal threshold load values for the portal server being sampled. Overload conditions are automatically communicated to a system administrator for remedial action to be taken.

### CROSS REFERENCE TO RELATED APPLICATION

This application is related to Patrick Petit et al., co-filed U.S. patent application Ser. No. ______ , filed on ______ , titled “SYSTEM AND METHOD OF DETERMINING THE NUMBER OF MEMORY FOR SIZING A PORTAL SERVER”, attorney docket No.: SUN/P7220/ACM/DKA and patent application Ser. No. ______ , filed on ______ , titled “SYSTEM AND METHOD OF DETERMINING THE NUMBER OF CENTRAL PROCESSING UNITS FOR SIZING APORTAL SERVER”, attorney docket No.: SUN/P7147/ACM/DKA. To the extent not repeated herein, the contents of the two patent application are hereby incorporated herein by reference.

### FIELD OF THE INVENTION

The present claimed invention relates generally to the field of corporate enterprise portal server systems. More particularly, embodiments of the present claimed invention relate to determining resource overload conditions in portal servers.

### BACKGROUND ART

The Internet has become a dominant vehicle for data communications with a vast collection of computing resources interconnected as a network from sites around the world. And with the growth of Internet usage has come a corresponding growth in the usage of Internet devices, wireless devices and services in ways different from the traditional uses of such devices.

The growing base of Internet users has become accustomed to readily accessing Internet-based services, which traditionally were restricted or limited to the “client/server” environment, at any time from any location. Accessibility of traditional business services and products over the Internet means enterprises need to adjust to new paradigms of business transaction.

Consequently, some organizations are, for example, implementing a variety of business resources and services. As businesses migrate to implementing numerous business applications on the Internet and web-based applications become pervasive in the enterprise business environment, businesses must find ways to protect their valuable resources and services over the Internet.

To achieve this, business are implementing several access authentication schemes in order to ascertain valid user access to such resources over the Internet. To access protected resources or services, users within a typical business enterprise environment must authenticate themselves to access webbased resources.

To facilitate these security measures, business organizations are making a transition from unsophisticated network infrastructure to a sophisticated network infrastructure. Additionally, portal services are becoming an essential part of today's network-centric computing infrastructure. In making such a transition, efficient management of services and resources offered by such intelligent networks become critical. Today, many organizations have mission critical applications for users and policies on individually configurable desktop machines. This time-consuming individual configuration process is unsuitable for enterprises and service providers seeking to create intelligent networks.

User management and policy based tools for managing services are becoming an important requisite for intelligent networks which should be capable of dynamically providing services. Furthermore, as businesses extend their intranet services to extranets to include suppliers, business partners, and customers, providing access control increases in size and complexity. Organizations responding to the rapidly changing conditions of today's business environments, need to simplify and automate the configuration and control of their services.

In making corporate services available to a large number of employees and customer base, security for information provided by corporations becomes critical. As corporate security takes the forefront of corporate computing, the use of virtual private networks has become an indispensable part of corporate networks.

A virtual private network (VPN) is a way to simulate a private network over a public network such as the Internet. The growth in the Internet and its popular information services, commonly known as the World Wide Web, has led to a popularity in the use of corporate intranets. Internally, companies are running TCP/IP networks (intranets) pushing information to their internal web-sites using web browsers as a common collaborative tool.

VPNs can be used to expand the reach of an intranet. Since intranets are typically used to communicate proprietary information, a company may not want just anyone on the Internet to have access to the information. There may be cases, however, where the company may want far-off offices to share data and information or for remote users to be able to connect to the company's intranet with corporate users using the Internet as a means of connection.

The need to share data within and outside the company's internal network has also led to the popularity of community web-based applications or portals. These portals enable users to share community based data, applications, service, etc., within a company. The increased use of such community based data sharing has led to the increased use of portal servers that connect a variety of users to the corporate intranet and the Internet.

Portal servers provide a secure way of connecting the corporate intranet to the Internet thereby reducing the fears that sensitive information might leave the corporate network to unauthorized destinations. A portal server also provides users the ability to connect to a corporate intranet via the Internet using a web browser without the user having to reconfigure their computer. The ease in connecting to corporate intranets via the portal server has made portal servers very attractive to many corporate information systems decision makers.

FIG. 1 is a block diagram illustration of a portal server environment. The portal server environment depicted in FIG. 1 comprises an enterprise portal server 110, a public network (the Internet) 115, a corporate intranet 120, back-end resource servers 130-140 and client computers 145-150. In the environment depicted in FIG. 1, client users 145-150 can directly access directories residing in the portal server 110 via the Internet 115 if such users are at a remote location. Similarly client 155 can access the same directory on the portal server 110 via the internal corporate intranet 120. Access to directories in the portal server 110 is subject to the user being authenticated by each individual application.

Since the portal server 110 may be accessed from a variety of venues (e.g., remotely or directly) the number of users accessing the portal server at any point in time can be very large. Thus, the load on the server 110 can be very high. The number of users concurrently connecting or attempting to connect to the portal server 110, may impact the performance of the portal server 110. On average, directories running on a reasonably fast server can be expected to handle around 800 or more search requests per second and thousands of simultaneous directory connections. However, there are many factors that can impact the server's performance. These factors include the amount of memory available to the server, the number of entries in directory databases, the number of types of indexes that the server uses to respond to search requests, and the amount of write activities performed on the server, etc.

As the load on the server grows, system administrators have to find ways of detecting and balancing the load in order to ensure the optimal performance of the portal server 110. System administrators typically use various manual techniques to determine ways to increase the performance of the server.

However, these manual determinations in performance improvements are done without any precise logic or formula to it and many times are done ad hoc and on trial and error basis. Thus, most of the server overload detection of the portal server 110 are done in ways that are not systematic, not reproduceable and not automatic. This can be an inefficient and ineffective way to improve the performance of the portal server 110.

### SUMMARY OF INVENTION

Accordingly, in order to reduce performance burdens that current portal users frequently encounter as the number of users and applications that access network applications from portal servers via the Internet or intranet increase, there is provided a way to for system administrators to automatically determine certain performance metrics to enhance load sizing requirements of the portal server. There should also be a way to allow the user to access multiple applications in the portal server without experiencing performance delays due to a lack of appropriate performance metrics being implemented because of ineffective and inefficient performance sizing methods.

As the number of business applications on the Internet increases, enterprise system users need easy and reliable ways to access multiple applications in a web based application environment without the inefficiencies of the prior art. An Internet infrastructure system is needed that has extensibility capabilities to allow access authentication and authorization to web-based resources and services in a business enterprise environment. Further, a need exists for a system and method of tracking user access to network resources and application services in order to provide optimal server service within a business environment. A need further exists for “out-of-the-box” load sizing solutions to allow network system administrators to connect portal servers to existing corporate networks to support a large number of users without the attendant performance problems of the prior art. A need further exists for an improved and less costly device independent portal server system, which improves efficiency and provides access to web-based content to various users of different configurations without losing the embedded features designed for these devices.

What is described, in one embodiment, is a load detection system and method having a portal server supporting a load sizing tool for determining resource overload in the portal server. This system provides predetermined primary metrics and secondary resources and services in a corporate portal server system environment that are used to generate appropriate metrics for sizing the portal server. In one embodiment of the present invention, the portal server system includes an authentication service system that authenticates user access requests to the portal server. A user access request is typically directed to web-based software applications and services which may be specific to an organization or an-entity. In one embodiment of the present invention, the authentication service system additionally includes a user agent policy system that sets user access policy to applications in the portal server.

The present invention further includes a session service that monitors a user's session after the user has been authenticated to access particular files or directories in the portal server. The session service provides the present invention with the ability to bypass user re-authentication after the user has been initially authenticated and validated. The session service also monitors user access requests to directories in the portal server.

Embodiments of the present invention include a resource sizing unit for determining an optimal number of central processing units (CPUs) for enhancing server performance in light of the number of concurrent users who connect to the portal server. The present invention uses primary sizing factors such as the maximum number of users that can connect to the portal server and the maximum number of concurrent users that may connect to the portal server at a particular point in time.

Embodiments of the resource sizing unit of the present invention also include a memory sizing module. The memory sizing module includes logic that allows a system administrator to automatically determine the optimal memory size to support the load on the server as the traffic on the server increases.

Embodiments of the present invention include a load detection module for detecting load increases on the server. Load increase in the server may be due to the increase in the number of concurrent users accessing various resources and applications on the server, e.g., directory resources.

Embodiments of the load detection module of the present invention include a concurrent user calculation module. The concurrent user calculation module calculates the maximum number of users that may concurrently connect to the portal server at any time and establishes a session during a user authentication sequence so that the user can be identified across different requests made to the server.

Embodiments of the present invention further include a set of dynamic register counters that are used by the load detection module to identify the performance throughput of the portal server. This is done based on the highest throughput from system start-up time and the lowest transaction time for a given time period.

Embodiments of the present invention further include a set of register counters for storing processing time values of the portal server during user requests to resources and applications in the portal server. The processing times of user requests are captured during various load data capture periods during the day. They enable the system administrator to automatically detect load conditions of the portal server at those various periods.

Embodiments of the present invention further include a load threshold value storage unit for storing an overload threshold value that serves as the optimum load condition in the portal server. During a system up-time of the portal server, load conditions are continuously monitored and compared with the threshold load value to determine whether the portal server had reached an overload condition.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

FIG. 1 is a block diagram of a portal server environment of the prior art;

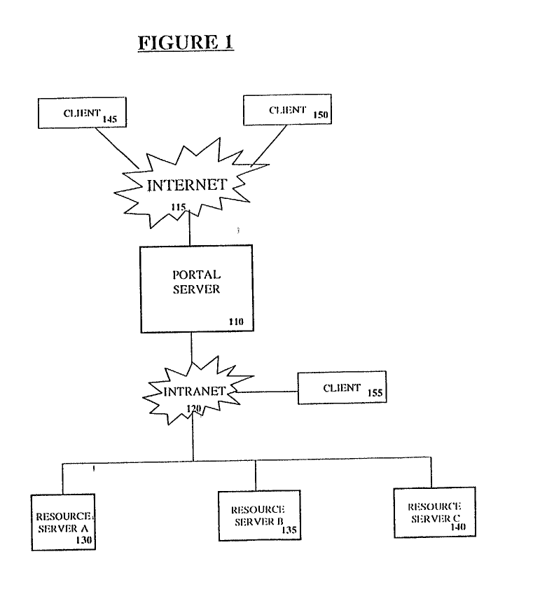

FIG. 2 is a block diagram of one embodiment of the portal server environment of the present invention;

FIG. 3 is a block diagram of one embodiment of the portal server of the present invention;

FIG. 4 is a block diagram of one embodiment of the performance requirements assessment module of the present invention;

FIG. 5 is a block diagram of an embodiment of the architecture of the load detection system of the present invention; and

FIG. 6 is a flow chart of an exemplary overload detection process of an embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the-invention as defined by the appended Claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

Embodiments of the invention are directed to a system, an architecture, subsystem and method to determine the optimal load required by a portal server for optimum performance. In one implementation, optimum performance is maximum throughput with minimum transaction time.

In the following detailed description of the present invention, a system and method for an overload condition detection in a portal server are described. Numerous specific details are not set forth in order to provide a thorough understanding of the present invention. However, it will be recognized by one skilled in the art that the present invention may be practiced without these specific details or with equivalents thereof.

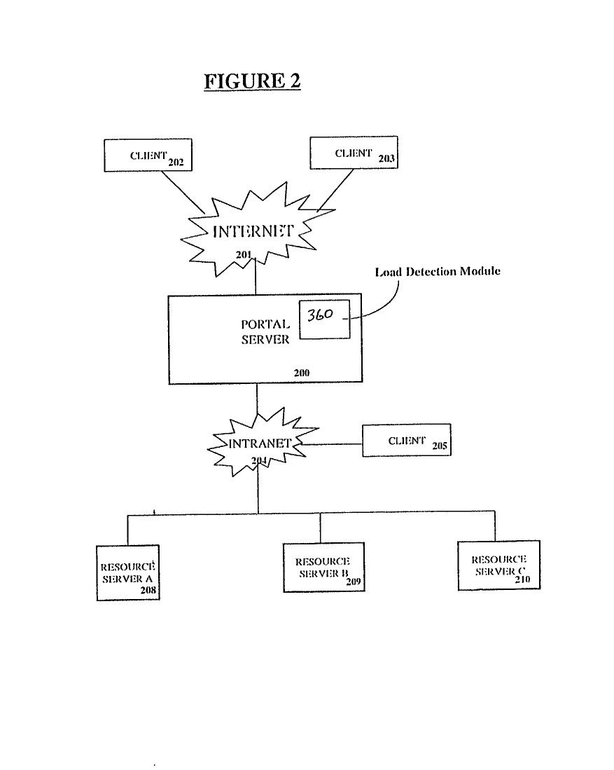

FIG. 2 is a block diagram illustration of a portal server environment. The portal server environment depicted in FIG. 2 comprises a portal server 200, a plurality of desktop or wireless clients 202 and 203 which are connected to the Internet 201, intranet 204, client 205 and back-end resource servers 208-210.

In the environment depicted in FIG. 2, a user can directly access the portal server 200 either via the Internet 201 or the intranet 204. As further depicted in FIG. 2, the portal server 200 comprises a load detection module 360 of the present invention.

In the environment depicted in FIG. 2, for the user to access protected resources or services, the user must authenticate. If the user authenticates successfully and if the user is authorized to access the resources, the user is given access to the resource. Content provided by the portal server 200 are provided in the form of various directories that may include content aggregated from the back-end resource servers 208-210. In the environment shown in FIG. 2, the portal server 200 tracks the initial desktop displays after the client has authenticated to the portal server 200 and the desktop reloads in order to generate the right metrics to measure the throughput of the portal server 200.

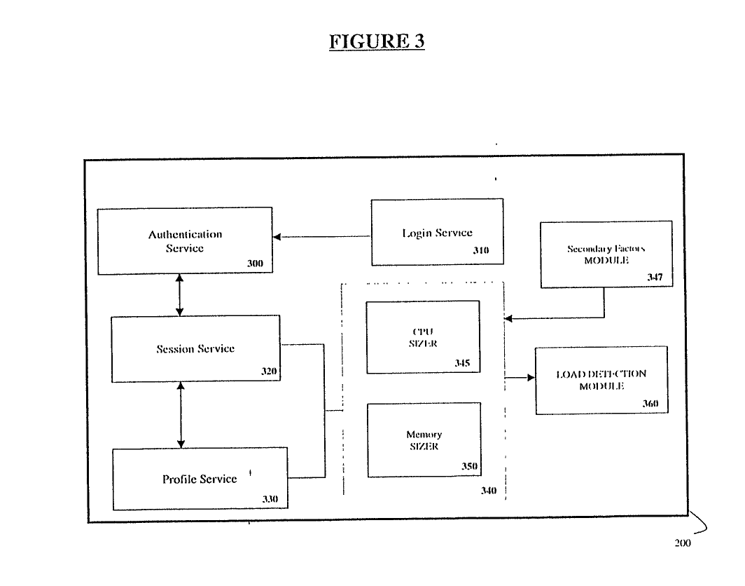

FIG. 3 is a block diagram depiction of one embodiment of the portal server 200 of-the present invention. In the exemplary diagram shown in FIG. 3, the portal server 200 comprises authentication module 300, login module 310, session module 320, profile module 330, sizing module 340 comprising CPU sizing module 345 and memory sizing unit 350, secondary factors module 347 and load detection module 360.

The authentication module 300 provides sign on service authentication of the present invention. The authentication module 300 provides the portal server 200 (FIG. 2) with the logic and option to protect Internet software applications and services from unauthorized authenticated users of these applications.

The authentication module 300 of FIG. 3 further provides the portal server 200 with the access implementation logic to selectively allow access to specified applications and services within enterprise organizations. By selectively allowing only authorized and authenticated users access to particular files within an organization's file database, the authentication module 300 ensures that corporate enterprise resources are efficiently and effectively utilized.

Further, the authentication module 300 allows authenticated users of the portal server 200 continuous and uninterrupted use of resources and applications available on the server 200. This enables the sizing logic of the present invention to accurately determine the number of users that are connected to the portal server 200 at any time.

The login module 310 provides login services to the portal server 200. Login module 310 includes logic to enable the tracking of a user's password to enable the sign-on services of the authentication process to function in the server 200.

Still referring to FIG. 3, the session module 320 provides a session tracking mechanism to enable the authentication logic of the present invention to track a user's login session to the portal server 200. The session module 320 logs the user's access of each application for which the user is authenticated to access. By logging the user's access to applications on the portal server 200, the authentication module is able to automatically authenticate the user's access to subsequent applications, after the initial login, without requiring a separate manual re-login.

The profile module 330 provides user profile information to the authentication module 300. The profile module 330 provides an XML over http(s) interface for obtaining user, service and policy information. A user's profile information typically includes the user-name, the user's password and the user's entity within a particular organization.

The profile information further defines the user's application access rights which determine or set forth user's rights to files and directory within applications and resources in portal server 200.

Central processing unit resource depletion in the portal server 200 is driven by the number of concurrent requests the portal server 2000 has to process per unit of time. Depletion of CPU resources generally results in degraded response time as a result of request queuing. The CPU sizing module 345 includes logic to monitor the number of users connected to the portal server 200, the maximum number of concurrent users connected to the portal server 200 and other secondary factors associated with the client's desktops connected to the portal server 200 to determine performance metrics to enhance the performance of the portal server 200. The CPU sizing module 345 provides a mechanism by which a system administrator can determine the number of CPUs a particular portal server may need for providing an efficient and effective utilization of the underlying portal resources by the users connected to the portal server 200.

The function of CPU sizing Module 345 is described in the U.S. patent application entitled “SYSTEM AND METHOD OF DETERMINING THE NUMBER OF CENTRAL PROCESSING UNITS FOR SIZING A PORTAL SERVER”, filed ______ , Ser. No. ______ , assigned to the assignee of the present invention and hereby incorporated herein by reference.

Memory resource depletion in the portal server 220 is driven by the number of outstanding sessions. Memory depletion typically results in degraded response time as a result of the increased garbage collection overhead and out-of memory exceptions in the portal server 200.

The memory sizing module 350 includes logic to monitor the number of users connected to the portal server 200, the maximum number of concurrent users connected to the portal server 200 and other secondary factors associated with the portal server 200 to determine performance metrics to enable the load detection module determine overload conditions of the portal server 200. The memory sizing module 350 provides a mechanism by which a system administrator can automatically determine the memory size that a particular portal server may need to provide an efficient and effective utilization of the underlying portal resources by the users connected to the portal server.

The function of memory sizing module 350 is described in the co-pending U.S. patent application entitled “SYSTEM AND METHOD OF DETERMINING MEMORY USAGE FOR SIZING A PORTAL SERVER”, filed ______ , Ser. No. ______ , assigned to the assignee of the present invention and hereby incorporated herein by reference.

The secondary factor module 347 calculates secondary factors such as the number of concurrent users connected to the portal server 200 and the maximum number of users connected to the portal server 200, etc. Data from the secondary factors module 347 is provided to the sizing module 340 and the load detection module 360 respectively. In one embodiment of the present invention, the count of the maximum number of connected users and the number of concurrent requests are provided by the secondary factors module 347 to the load detection module 360. This information helps determine the threshold load conditions in the portal server 200.

The load detection module 360 monitors resource usage of users concurrently connected to the portal server 200 in order to detect overload conditions in the portal server. In one embodiment of the present invention, the load detection module 360 is programmable to capture load conditions in the portal server 200 during sampling periods. The load sampling periods of the load detection module 360 may last from a few seconds to a few minutes.

During the load sampling period, the load detection module 360 examines the current load values in the portal server 200 and compares those values with the pre-determined threshold optimal load values stored in the load detection module 360 to determine whether the current load values exceed the threshold values or exceed the load values from the most previous sampling period. In one embodiment of the present invention, the load sampling period is programmable to be random or serialized over specific times of the day during system up-time.

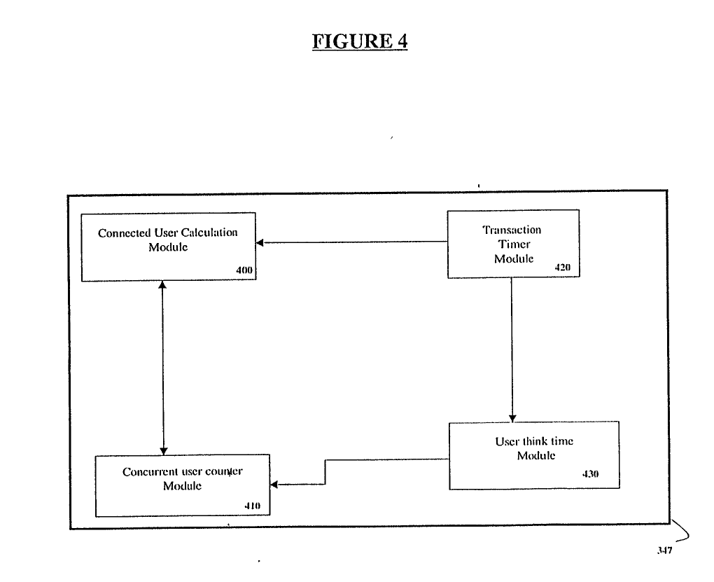

FIG. 4 is block diagram depiction of one embodiment of the performance requirement assessment module 347 of the present invention. The performance requirement assessment module 347 comprises a connected user calculation module 400, a concurrent user counter 410, transaction timer module 420 and user think-time module 430.

The connected user calculation module 400 calculates the maximum number of users or sessions connected to the portal server 200. A connected user is a user who has a valid portal session open, but who may not be active at a certain time. The maximum number of users is generally a percentage of the user base that can be obtained from different sources, such as usage statistics or web traffic analysis for an existing portal or web application.

The web traffic metric representing the best value to calculate the maximum number of connected users is often called visitor sessions (e.g., a single visitor visit within a predefined period of time). Depending on the portal audience and portal type (e.g., business to employee or business to customer portal), that percentage can vary from a fraction of the user base to the entire user base. For example, in a corporate environment, the total user base may be based on the number of active employees, not including employees that are either on the road, on vacation, or are out sick.

In the present invention, another variable that needs to be considered to determine the maximum number of connected users by the connected user calculation module 400 involves whether the maximum number of users calculated were calculated based on regular or peak server load conditions. The periodicity and amplitude of the peaks of load can substantially vary over time, but once they have been identified, the resulting number of connected users tends to be relatively steady for the observed period.

In one embodiment of the present invention, to calculate the maximum number of concurrent users, the concurrent user calculation module 410 uses a user interactivity profile to determine the number of users connected to the portal server 200. The user interactivity profile defines the number of hits registered to the portal server 200 per unit of time called the reference time period.

The concurrent user counter module 410 is coupled to the connected user calculation module 400 to tabulate the maximum number of concurrent users connected to the portal server 200 at any point in time. The contents of the concurrent user counter module 410 are provided to the load detection module 360 during a load sampling period to enable the load detection module 360 to determine whether the current count of concurrent users or requests exceeds the pre-determined threshold values.

The user think time module 430 is coupled to calculate the user think time. The user think time defines the time elapsed between desktop clicks resulting in HTTP operations to the portal server 200 as opposed to the external resource servers 208-210. From the portal server's perspective, the think time could be anything from the time taken by the user to enter the user's authentication credentials, the time taken by the user to read a portal page or even the user's session or idle time-out if the user walks away from his desktop for an extended period of time. The think time then amounts to idle times for the portal server 200 and is equivalent to no user at all except until the session is terminated (e.g., logout or session time-out).

Still referring to FIG. 4, the transaction timer module 420 is coupled to the connected user calculation module 400 and the think time module 430 to determine the transaction time for a user to complete an operation. The transaction time is the delay taken for an HTTP or HTTP(s) operation to complete. The metric gathered from this includes the aggregated send time, processing time and response time sub-metric. Depending on a browser's connection, delay may vary for speed, send time and response time.

Typically, a response time delay will be longer with a connection speed of about 33.6 Kps than with a LAN connection speed. However, the processing time remains constant. The portal server 200 is timed so that the processing time under regular or peak load conditions do not exceed a certain threshold as far the performance requirements are concerned.

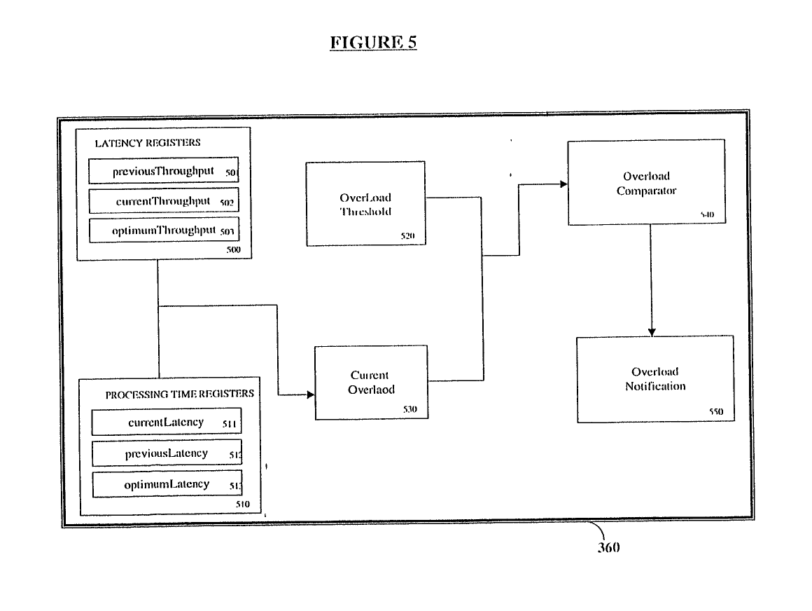

FIG. 5 is a block illustration of one embodiment of the load detection module of the present invention. As shown in FIG. 5, the load detection module 360 comprises throughput counters 500, processing time counters 510, threshold load value storage unit 520, current load values storage unit 530, load values comparator unit 540 and overload notification unit 550.

The process life span of the portal server 200 is typically divided into configurable periods of a few second or minutes during system uptime that system resource utilization in the portal server 200 is monitored. During these configurable periods, the load detection module 360 calculates load conditions in the portal server and measures the current load conditions against the threshold load value to determine whether the portal server 200 is in an overload condition.

The throughput counters 500 stores throughput values of the portal server 200 during the various user access data capturing periods. The throughput counters 500 comprise previous throughput counter 501, current throughput counter 502 and optimum throughput counter 503.

The previous throughput counter 501 maintains the average throughput for a previous capturing period when the load detection module 360 last monitored load conditions in the portal server 200. The load detection module 360 moves the current throughput value into the previous throughput counter 501 after a current load sampling period.

The current throughput counter 502 stores the average current throughput value of the current load monitoring sampling period. The current throughput counter 502 is incrementally increased by new requests received by the portal server 200 from a user connecting or connected to the portal server 200. The current throughput counter 502 enables the load detection module 360 determine load conditions at any particular point in time during system uptime.

The optimal throughput counter 503 stores the highest throughput value ever registered by the load detection module 360 since the beginning of the load detection process.

The processing time (latency) counters 510 store the processing time values of requests submitted to the portal server 200. Typically, the processing time of user request on the average is a constant regardless of the portal server's 200 load conditions until the portal server 200 reaches its optimum performance. In one embodiment of the present invention, the portal server's 200 optimum performance is characterized by the highest request throughput for the lowest request latency registered during the portal server's 200 uptime.

Still referring to FIG. 5, the current latency counter 511 stores the average current latency value for the actual load sampling period. The load detection module 360 checks the contents of the current processing time counter 511 to store the processing time of each user request.

The previousLatency counter 512 stores the average latency for previous and sliding sampling periods. The load detection module 360 transfers the contents of the currentlatency counter 511 into the previousLatency counter 512 after each sampling period. The lowest latency values for optimum performance of the portal server 200 are stored in the optimumLatency counter 513. The lowest latency value like the threshold load value is pre-determined at the startup of the portal server 200.

Threshold value storage unit 520 stores the values of the load threshold that are typically pre-determined by the system administrator of the portal server 200. In one embodiment of the present invention, the threshold load value is used by the load detection module 360 during load sampling periods to determine whether the current load values exceed the threshold load values. In one embodiment of the present invention, the threshold load values define the maximum number of concurrent users during peak hours which is derived by the following formula:

cu=U*P*I

Where

Cu is-the maximum number of concurrent users;

U is the number of the user base;

P is the percentage of the user base that may be connected to the portal server during peak times; and

I is the user interactivity profile which represents the number of times that the user on average accesses their desktop after any initial login.

The current load value storage unit 530 stores the current load value determined by the load detection module 360 during a load sampling period. The contents of the current load storage unit 530 are compared with the contents of the threshold value storage unit 520 in the comparator storage unit 540 to determine whether the current load conditions exceed the threshold load conditions. If the current load value is higher than the threshold load value, the comparator storage unit 540 triggers the overload notification unit 550 to automatically notify the system administrator of an overload condition in the portal server 200.

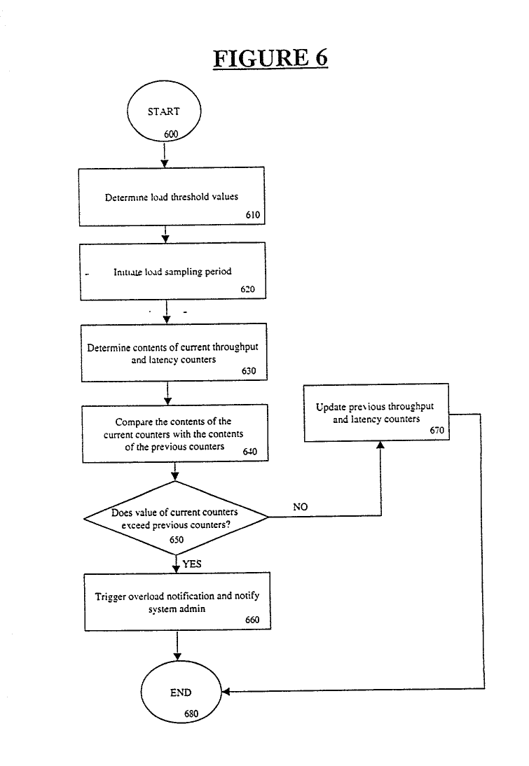

FIG. 6 represents a flow diagram depiction of an exemplary computer implemented process in accordance with one embodiment of the overload detection processing of the present invention. The steps performed by the diagram of FIG. 6 are performed by a computer processor executing memory stored instructions which make up a program or application.

The overload condition in the portal server 200 is primarily determined by the number of concurrent users and the number of HTTP operations (or transactions) generated by all the concurrent users per unit of time. Typically HTTP operations to the portal server 200 are a mix of get and post requests to the underlying servlet engines for creating portal sessions, initializing desktops and desktop reloads.

As shown in FIG. 6, resource overload detection in the portal server 200 is initiated at step 600. At step 610, the load detection module 360 predetermines the optimal threshold load values of the portal server 200. In one embodiment of the present invention, the threshold load values include predetermining the maximum number of concurrent users that may connect to the portal server 200.

Alternatively, the maximum number of concurrent user requests may be used as the load threshold values. Additionally, the threshold throughput and latency to handle the optimal number of concurrent users or concurrent requests are calculated to generate the threshold load values. Typically, the threshold load value stays constant for a given port server deployment, unless resources such as CPU, memory, number of base users, etc., change.

Load data sampling 620 is initiated by the load detection module 360 to determine load conditions in the portal server 200 at any point in time. During the load data sampling 620, the load detection module 360 examines counter registers 500 and 510 in order to gather the relevant load data to determine overload conditions.

At step 630, the load detection module 360 checks the contents of the current throughput and latency counter registers to get the current load values of the portal server 200. The values of the current counter registers are compared 640 with the value of the contents of threshold counter registers 503 and 513. The contents of previous counter registers 501 and 512 are obtained from previous load sampling periods conducted by the load detection module 360.

At step 650, if the contents of the current counter registers 502 and 511 exceed the contents of the threshold or optimum counter registers 503 and 513, the system administrator is automatically notified 650 of resource overload condition in the portal server 200. If, on the other hand, at step 670 the current load values do not exceed the threshold values the load detection module 360 updates previous counter registers 501 and 511 with the current load values until the next sampling period.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the Claims appended hereto and their equivalents.

1. A portal server, comprising:
an authentication module for authenticating user credentials for users requesting connection to said portal server;
a session module coupled to said authentication module to monitor authenticated user access to said portal server;
a profile module coupled to said session module to store user profile information for users successfully authenticating to said portal server;
a resource sizing module for determining the optimal number of central processing units and memory required by said portal server for optimum performance; and
a load detection module for detecting resource usage overload conditions defining the maximum number of concurrent users connected to said portal server.

2. The portal server of claim 1, wherein said load detection module comprises a first plurality of counters for maintaining load throughput values for determining the optimum throughput of said portal server.

3. The portal server of claim 2, wherein said load detection module further comprises a second plurality of counters for maintaining load latency values for determining the optimum latency of processing user requests to said portal server.

4. The portal server of claim 3, wherein said load detection module further comprises a load threshold value storage unit for storing a load threshold value representing the optimal load in said portal server.

5. The portal server of claim 4, wherein said load detection module further comprises a current load value storage unit for storing the current load value of said portal server during a load sampling period.

6. The portal server of claim 5, wherein said load detection module further comprises a load value comparison unit for storing a resource overload value generated when said current load value exceeds said threshold load value.

7. The portal server of claim 6, wherein said load detection module further comprises an overload notification module for automatically notifying a system administrator of a resource overload condition in said portal server when the contents of said load value comparison unit detects that said load threshold value exceeds said current load value.

8. The portal server of claim 1, wherein said resource sizing module comprises a secondary sizing factors assessment module for gathering secondary sizing factor metrics used in determining performance metrics of said portal server.

9. The portal server of claim 2, wherein said first plurality of counters comprise a first counter for maintaining current throughput values during said load sampling period.

10. The portal server of claim 9, wherein said first plurality of counters further comprise a second counter for maintaining a threshold throughput value corresponding to the optimal throughput value for said portal server.

11. The portal server of claim 10, wherein said first plurality of counters further comprise a third counter for maintaining a previous throughput value corresponding to a throughput obtained during a previous load sampling period.

12. The portal server of claim 3, wherein said second plurality of counters comprises a first counter for maintaining the current average latency value for said load sampling period.

13. The portal server of claim 12, wherein said second plurality of counters further comprise a second counter for maintaining the average latency value for a previous load sampling period.

14. The portal server of claim 13, wherein said second plurality of counters further comprise a third counter for maintaining the lowest latency value for the highest throughput of said portal server.

15. A load detection module for detecting resource use overload conditions in a portal server, comprising:
a first plurality of counters for storing throughput values of user requests to said portal server;
a second plurality of counters for storing latency values for said user requests;
a load threshold storage unit for storing the optimal load value for said portal server, wherein said load value defines the maximum number of concurrent users that may concurrently connect to said portal server at any given time; and
an overload condition generation unit for generating an overload signal in response to overload conditions in said portal server.

16. The load detection module of claim 15, further comprising a current load value storage unit for storing the current load value of said portal server during a load sampling period.

17. The load detection module of claim 15, further comprising a load value comparison unit for storing a resource overload value generated when said current load value exceeds said threshold load value.

18. The load detection module of claim 16, further comprising an overload notification module for automatically generating a system administrator notification of resource overload condition in said portal server when the contents of said load value comparison unit indicate said threshold load value exceeds said current load value.

19. The load detection module of claim 15, wherein said first plurality of counters comprise a first counter for maintaining current throughput values during said load sampling period.

20. The load detection module of claim 19, wherein said first plurality of counters further comprise a second counter for maintaining a threshold throughput value corresponding to the optimal throughput value for said portal server.

21. The load detection module of claim 20, wherein said first plurality of counters further comprise a third counter for maintaining a previous throughput value corresponding to a throughput obtained during a previous load sampling period.

22. The load detection module of claim 19, wherein said second plurality of counters further comprise a first counter for maintaining the average latency value for a previous load sampling period.

23. The load detection module of claim 22, wherein said second plurality of counters further comprise a second counter for maintaining the lowest latency value for the highest throughput of said portal server.

24. The load detection module of claim 15, wherein said load value further defines the maximum number of user requests that may concurrently be processed by said portal server.

25. A method of detecting resource use overload in a portal server, comprising:
determining the maximum average number of concurrent users that may connect to said portal server;
determining the maximum number of concurrent user requests to said portal server;
determining resource throughput values defining resource load conditions during a load sampling period in said portal server;
determining resource latency values defining resource load conditions during said load sampling period;
determining resource overload conditions during said resource load sampling period; and
automatically signaling resource use overload conditions in said portal server.

26. The method of claim 25, further comprising calculating a resource use threshold value defining the optimal number of concurrent users connected to the portal server at any particular point in time without substantially degrading the performance of said portal server.

27. The method of claim 25, further comprising calculating a resource use threshold value defining the optimal number of concurrent user requests processed by the portal server at any particular point in time without substantially degrading the performance of said portal server.

28. The method of claim 27, wherein said detecting said overload condition comprises comparing current resource load values with said load threshold values to determine if said current resource load values exceed said threshold load values.

29. The method of claim 28, wherein if said current resource load values exceed said threshold load values, activating said overload notification.
